(19) United States
(12) Patent Application Publication
(10) Pub. No.: US 2015/0208629 A1
(43) Pub. Date: Jul. 30, 2015

(54) FISHING ROD WITH PLUG STOWAGE AND BASE SECTION RETAINER

(71) Applicant: Daniel Galhardo, Boulder, CO (US)

(72) Inventor: Daniel Galhardo, Boulder, CO (US)

(21) Appl. No.: 14/564,887

(22) Filed: Dec. 9, 2014

Related U.S. Application Data
(60) Provisional application No. 61/913,570, filed on Dec. 9, 2013.

(51) Int. Cl. A01K 87/02

(52) U.S. Cl. CPC A01K 87/025

(57) ABSTRACT

A fishing rod of a type that has multiple sections assembled together in a telescopic manner in which smaller diameter, more distal sections collapse telescopically into and extend telescopically out of one or more larger diameter, more proximal sections that extend from a handle includes a rod plug that is sized and shaped for removable mounting in a distal end of the larger diameter section to retain the smaller diameter sections when collapsed into the larger diameter section and a handle plug with a storage hole that is sized and shaped to receive and retain the rod plug in a removable manner. A base section retainer apparatus receives and releaseably holds a proximal end of the base section in the handle.

### BACKGROUND OF THE INVENTION

1. Field of the Invention

The present invention relates generally to fishing rods, and more specifically to a plug stowage feature for fishing rods.

2. Description of the Prior Art

Some fishing rods, for example, but not for limitation, have a plurality of telescopically assembled rod sections that can be collapsed wholly or partially into a base section, which may or may not include a handle, and which can be telescopically extended to for use in fishing. Some such fishing rods also have a rod plug that is sized and shaped for insertion into, and to fit snugly in, the distal end of either the base section of the rod or one of the larger diameter, extendable sections, depending on the length of the sections, when the extendable sections of the rod are telescopically collapsed into the base section. The purposes for such rod plugs may include: (i) to close the distal end of the base section or the other larger section to capture and retain the smaller diameter sections in the base section or the larger diameter section for storage; (ii) to protect the distal end of the base section or the larger diameter section from damage during periods of non-use, transportation, or storage of the rod; and (iii) to prevent debris or other contaminants from entering the base section or the larger diameter section during periods of non-use, transport, or storage of the rod. Of course, the fit of the rod plug in the distal end of the base section is snug enough to remain in place during such periods of non-use, transportation, and storage of the fishing rod, but not so snug as to prevent a user from easily removing the rod plug in order to telescopically extend the extendable section of the fishing rod for use in fishing.

The foregoing examples of the related art and limitations related therewith are intended to be illustrative and not exclusive. Other limitations of the related art will become apparent to persons skilled in the art upon a reading of the specification and a study of the drawings.

### BRIEF DESCRIPTION OF THE DRAWINGS

The accompanying drawings, which are incorporated herein and form a part of the specification, illustrate some, but not the only or exclusive, example embodiments and/or features. It is intended that the embodiments and figures disclosed herein are to be considered illustrative rather than limiting. In the drawings:

FIG. 1 is an isometric view of an example fishing rod in non-use, telescopically collapsed configuration, e.g., for non-use, transportation, or storage, with the protective rod plug inserted into the distal end of one of the larger diameter extendable sections of the rod;

FIG. 2 is a similar isometric view of the example fishing rod in FIG. 1, but with the protective rod plug removed from the distal end of the larger diameter extendable section of the rod and illustrating several of the smaller diameter, extendable sections of the rod protruding slightly from the distal end of the larger diameter, extendable section;

FIG. 3 is an exploded isometric view of the proximal end of the handle portion of the example fishing rod in FIG. 1, including the coupling insert, the handle plug, and the rod plug;

FIG. 4 is an isometric view similar to FIG. 3, but with the coupling insert mounted in the proximal end of the handle and with the rod plug mounted in the handle plug;

FIG. 5 is an isometric view similar to FIGS. 3 and 4, but with the handle plug mounted in the coupling insert and with the rod plug mounted in the handle plug;

FIG. 6 is a side elevation view of the example fishing rod in FIG. 1 in the non-use, telescopically collapsed configuration with the protective rod plug inserted into the distal end of the base section of the rod;

FIG. 7 is a fragmented, side elevation view of the example fishing rod in FIG. 1 illustrating the fully extended, use configuration of the fishing rod with the rod plug stowed in the handle plug;

FIG. 8 is a cross-sectional view of the example fishing rod taken substantially along section line 8-8 in FIG. 6;

FIG. 9 is a cross-sectional view similar to FIG. 8, but with the fishing rod sections in the fully extended, use configuration as shown in FIG. 7;

FIG. 10A is an enlarged cross-sectional view of the rod plug mounted in the distal end of the base section of the example fishing rod as illustrated in FIG. 8;

FIG. 10B is an enlarged cross-sectional view of the handle plug mounted in the proximal end of the handle of the example fishing rod as illustrated in FIG. 8

FIG. 10C is an enlarged cross-sectional view of the rod plug mounted in the handle plug in the proximal end of the handle as illustrated in FIG. 9, but with the proximal end of the base section of the example fishing rod retained in the coupling insert in the proximal end of the handle for use of the example fishing rod in a partially extended configuration;

FIG. 10D is an enlarged cross-sectional view of the rod plug mounted in the handle plug in the proximal end of the handle as illustrated in FIG. 9, but with the proximal end of the base section of the example fishing rod pulled out of the coupling insert for full extension of the of the example fishing rod;

FIG. 11 is an enlarged, transverse cross-sectional view of the example fishing rod taken substantially along the section line 11-11 in FIG. 8 with the rod sections in the collapsed configuration;

FIG. 12 is an enlarged, transverse cross-sectional view of the example fishing rod taken substantially along the section line 12-12 in FIG. 9 with the rod sections in the extended configuration;

FIG. 13 is an isometric view of another example fishing rod that has a handle molded or mounted on the proximal end of the base section such that the base section and the handle are immovable in relation to each other and illustrating the rod plug mounted in a handle plug in the proximal end of the handle; and

FIG. 14 is a cross-section view of the example fishing rod in FIG. 13 with the telescopically extendable rod sections in a non-use configuration collapsed and nested in the base rod section.

### DETAILED DESCRIPTION OF EXAMPLE EMBODIMENTS

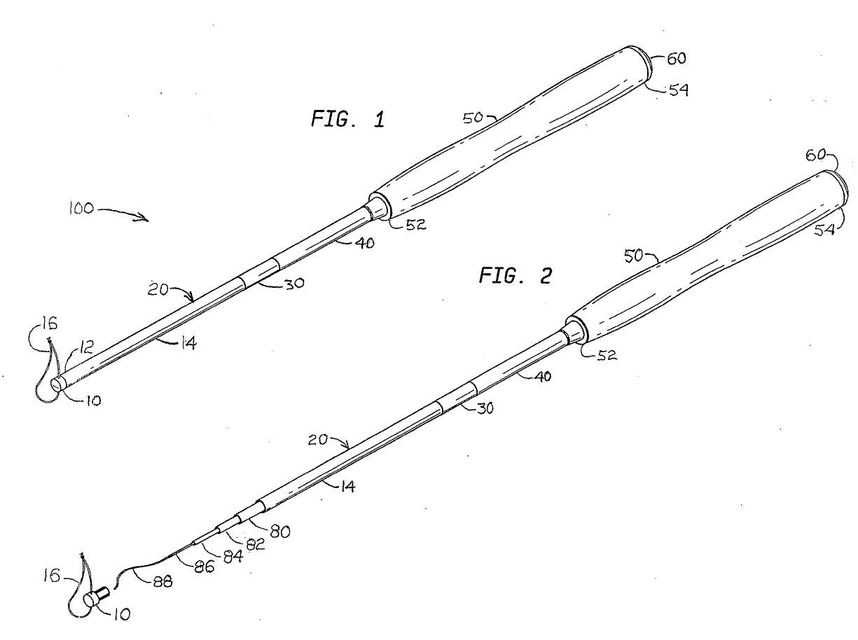

An example telescopically extendable and collapsible fishing rod assembly 100 is illustrated in FIG. 1 in a collapsed, non-use configuration with a rod plug 10 mounted in the distal end 12 of a larger diameter section 14 of the rod 20, where it is mounted to, for example: (i) close the distal end 12 of that section 14 to capture and retain the collapsed, smaller diameter sections, (not seen in FIG. 1) inside that larger diameter section 14 for storage; (ii) protect the distal end 12 of that larger diameter section 14 from damage during periods of non-use, transportation, or storage of the fishing rod assembly 100; and (iii) prevent debris or other contaminants from entering that section 14 during periods of non-use, transport, or storage of the fishing rod assembly 100. In this example fishing rod assembly rod 100, the larger diameter rod section 14 in which the rod plug 10 is mounted is the second largest diameter section, just slightly smaller in diameter than the base section 30. The base section 30 is telescopically collapsible into a sleeve 40 on which a handle 50 is mounted, and the second largest diameter section 14 is telescopically collapsible into the base section 30. The sleeve protrudes axially from the distal end 52 of the handle 50. A looped cord 16 or other handle is provided on the rod plug 10 to accommodate a user grasping and pulling on the rod plug 10 to remove it from the distal end 12 of the second rod section 14. A handle plug 60 is mounted in the proximal end 54 of the handle 50 to retain the collapsed sections of the rod 20, as will be described in more detail below.

In FIG. 2, the rod plug 10 is shown removed from the distal end 12 of the second rod section 14, and several of the intermediate and more distal, smaller diameter rod sections 80, 82, 84, and 86 are shown partially emerging from the distal end 12 of the second rod section 14. A short piece of string 88 extends from the distal end of the smallest diameter, most distal, rod section 86, which also collapses into the second rod section 14 for storage along with the most distal rod section 86. Fishing line can be attached to the string 88 when the fishing rod assembly 100 is used for fishing. As indicated above, the rod 20 could be made with a base section 30 that is long enough to receive all of the other rod sections, including the second rod section 14, in which case, the rod plug 10 could be sized and shaped to fit snugly into the distal end of the base section 30. Also, there can be any convenient number of other telescoping rod sections, depending on the overall length and the collapsed length desired and the diameter dimensions of the rod sections, as will be understood by persons skilled in the art once they have read this description and understand the invention. With such options and variations in mind, this description will proceed based on the example fishing rod assembly 100 shown in FIGS. 1-12, but with the understanding that the invention is not limited to only that example.

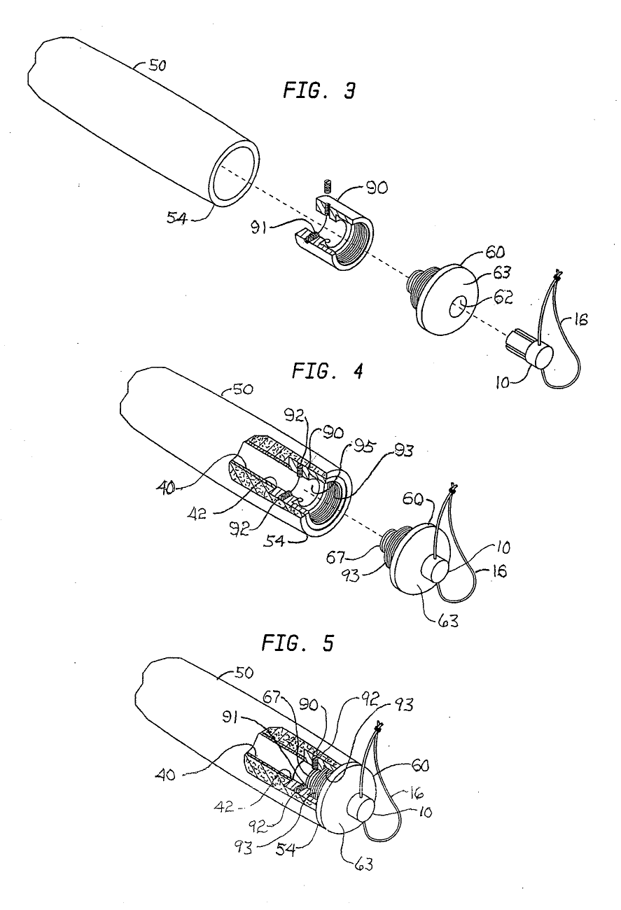

When the rod plug 10 is removed from the distal end of the second section 14, as shown in FIG. 2, for fishing, it can be lost or misplaced quite easily, because it is small, and a fisherman's hands are often quite occupied in carrying the fishing rod assembly 100 as well as in making leaders, attaching flies, carrying other equipment, moving tree branches, etc. Even placing the rod plug 10 in pockets or containers is inconvenient. Therefore, the handle plug 60 in this example fishing rod assembly 100 is provided with a storage hole 62 extending into its proximal surface 63 that is sized and shaped to snugly receive and retain the rod plug 10, as shown in FIGS. 3, 4, and 5, for convenient stowage of the rod plug 10 while the fishing rod 100 is in use. The inside diameter of the storage hole 62 is substantially the same as the inside diameter of the distal end 12 of the second rod section 14, so, like the fit of the rod plug 10 in the second rod section 14, the fit of the rod plug in the storage hole 62 is snug enough to retain the rod plug securely in the handle plug 60 during fishing, but not so snug as to be difficult to remove when it is desired to put the rod plug 10 back into the distal end 12 of the second rod section 14 when the intermediate and distal rod sections 80, 82, 84, 86 are telescopically collapsed into the second rod section 14.

As shown in FIGS. 3-5, the handle plug 60 is removably mountable in a coupling insert 90 in the proximal end 54 of the handle 50. As mentioned above, a sleeve 40 extends longitudinally through the handle 50 from the distal end 52 of the handle 50 (FIGS. 1 and 2) toward, but not all the way to, the proximal end 54, as shown in FIGS. 4 and 5. The coupling insert 90 extends from the proximal end 54 of the handle 50 longitudinally into a larger diameter bore 56 in the handle 50 into abutment with the proximal end 42 of the sleeve 40. The interior diameter of the coupling insert 90 matches the interior diameter of the proximal end 42 of the sleeve 40, so that the base section 30 (FIGS. 1 and 2) can extend through the sleeve 40 and into the coupling insert 40 as will be explained in more detail below. A plurality of set screws 92 extend transversely through the coupling insert 40 as shown in FIGS. 4 and 5 and can be adjusted radially in order to slidably, but snugly receive the proximal end of the base section 30 (not seen in FIGS. 4 and 5) as will also be explained in more detail below. The handle plug 60 has an exterior threaded portion 65, which screws into an inside threaded portion 93 of the coupling insert 90, and a nipple 67 that extends into the bore 95 of the coupling insert 90 when the handle plug 50 is screwed into the coupling insert 90 as shown in FIG. 5. Of course, other handle plug configurations could also be used and provided with the storage hole 62 for the plug 10. For example, instead of threads, the handle plug could have a smooth, snug fit in the coupling insert or some type of detent or resiliently yieldable latch, color, rim, or groove or some combination of such structures could be provided to releasably retain the handle plug in the coupling insert. Also, the nipple 67 is provided to receive and yieldably retain the proximal end 32 of the base section 30.

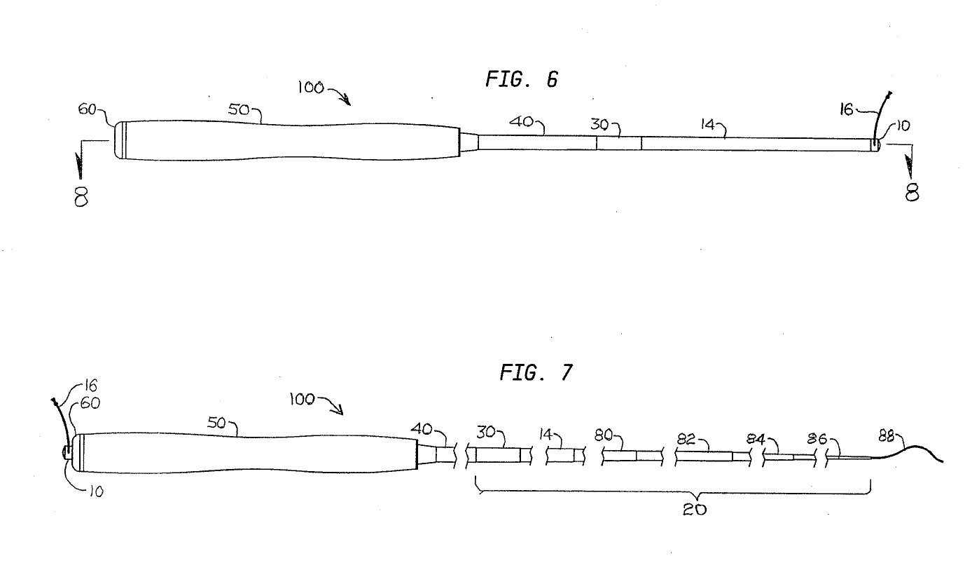

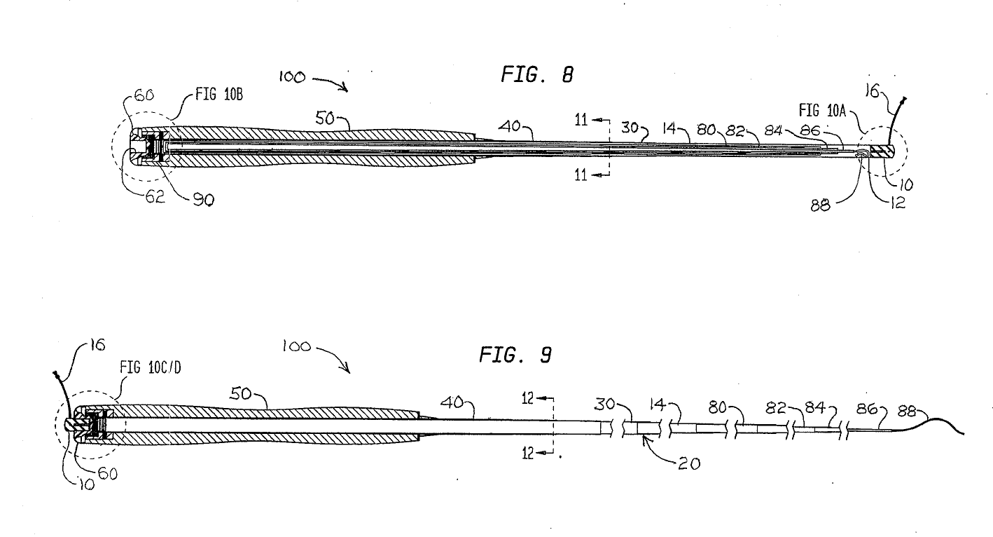

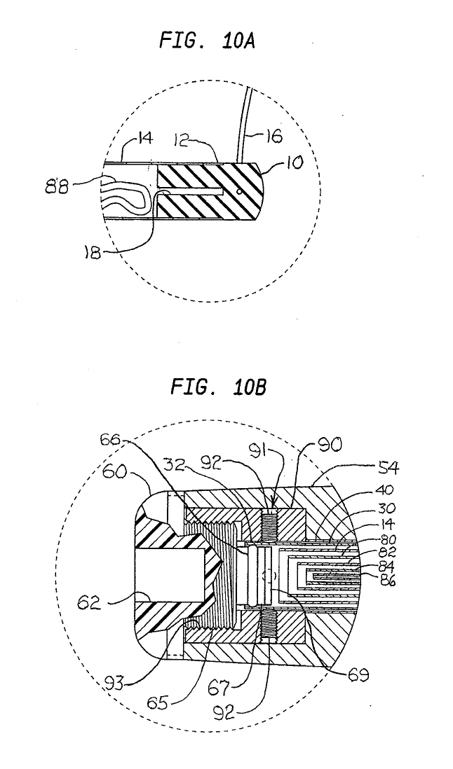

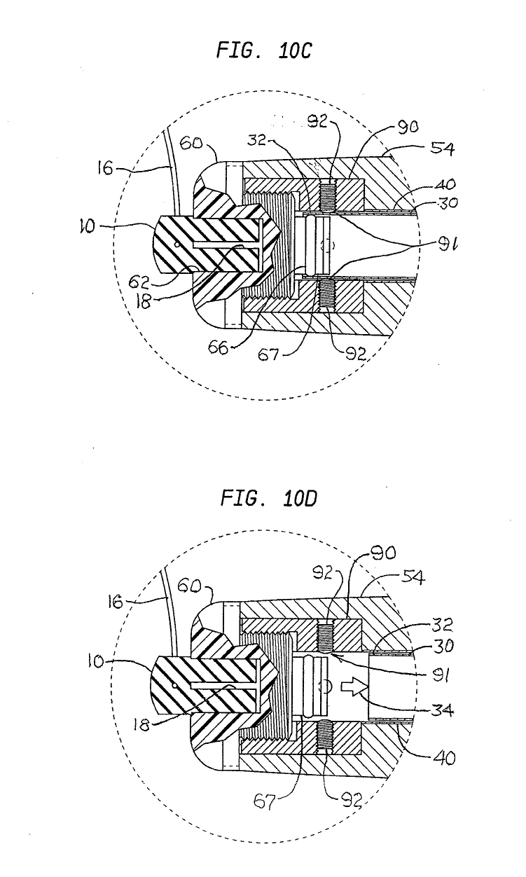

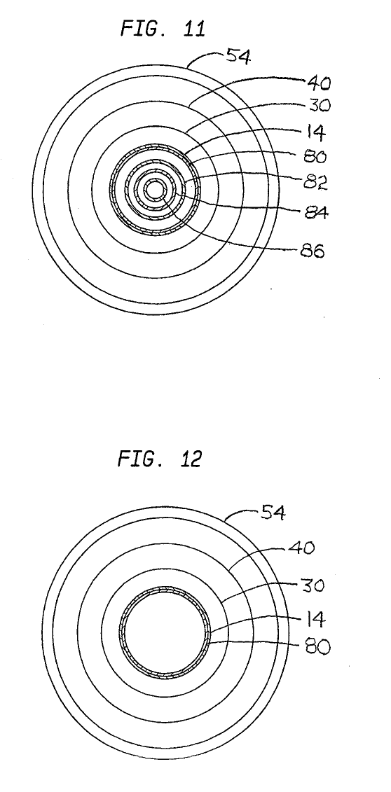

FIGS. 6 and 8 illustrate the example fishing rod assembly 100 with the second rod section 14 telescopically collapsed into the base section 30 and sleeve 40 and with the intermediate and distal rod sections 80, 82, 84, 86 telescopically collapsed and nested inside the base rod section 30 and second rod section 15 as explained above. In that non-use configuration, the rod plug 10 is positioned in the distal end 12 of the second rod section 14 as best seen in the enlarged cross-section view in FIG. 10A and as also explained above. The handle plug 60 is also screwed into the coupling insert 90 to prevent the nested rod sections 80, 82, 84, 86 from falling out of the proximal ends of the sleeve 40 and handle 50. A resilient pad A transverse slot 18 in the rod plug 10 facilitates some resilient, elastic deformation of the rod plug 10 as it is forced into the distal end 12 of the rod section 14.

The sleeve 40, base rod section 30, second rod section 14, and other intermediate and distal rod sections 80, 82, 84, 86 are tapered from their respective larger proximal cross-sections to their respective smaller distal cross-sections, as can be seen FIG. 8, so that they can be telescopically extended in relation to each other, but only to the full length of each respective section and no more. In other words, the proximal cross-section of each rod section is larger than the distal cross-section of the rod section that immediately surrounds it. Therefore, the proximal end of each rode section cannot be pulled through the distal end of the immediately adjacent, surrounding rod segment. Consequently, the rod 20 can be telescopically extended to a full length as determined by the lengths of the respective rod sections that can be pulled out of the immediately adjacent, surrounding rod section before the larger proximal end of each respective rod section binds with the smaller distal end of the immediately adjacent, surrounding rod section, as shown in FIGS. 9, 11, and 12. In the cross-section view in FIG. 12, the rod 20 is extended, and the proximal end of rod section 80 is shown in binding relation to the distal end of the immediately adjacent, surrounding rod section 14.

As best seen in FIG. 10B, the proximal ends of the rod sections 30, 14, 80, 82, 84, 86 nest in the proximal end of the sleeve 40 and in the coupling insert 90 when they are collapsed to the non-use configuration of FIGS. 6 and 8. A resilient end pad 69 cushions the end of the nipple 67 for contact with the distal ends of the rod sections in this non-use configuration. As also shown in FIG. 10B, the distal end 32 of the base section 30 can be pushed over a ridge 66 extending radially outward from the peripheral surface of the nipple 67 of the handle plug 60. The ridge may be provided by any convenient structure, for example, a resiliently elastic O-ring that is sized to fit snugly in the proximal end 32 of the base rod section 30, which yieldably inhibits longitudinal movement of the base rod section 30 out of the sleeve 40. A base section retainer feature 91 in the coupling insert 90 engages the proximal end 32 of the base section 30 to yieldably inhibit longitudinal movement of the base section out of the sleeve 40. The example retainer feature 91 shown in FIGS. 10B, 10C, and 10D includes the set screws 92 that extend transversely through the coupling insert 90, which can be adjusted radially inward to contact and, if desired, apply a radially inward directed force on the peripheral surface of the base rod section 30 to the extent desired for resisting a longitudinal force applied by a user to pull the proximal end 32 of the base rod section 30 off and away from the nipple 67. This feature enhances the inhibition of longitudinal movement of the base section 30 by the nipple 67 and ridge 66 and enables the fishing rod assembly 100 to be used in a partially extended configuration with the base rod section 30 securely retained in the collapsed position in the sleeve 40, as illustrated in FIG. 10C, while the more distal rod sections 14, 80, 82, 84, 86 are extended. In that configuration, the overall length of the rod 20 is shorter than if the base rod section 30 is fully extended out of the sleeve 40, thus providing a shorter overall fishing rod assembly 100, which may be useful, for example, when fishing narrow streams with overhanging tree branches and similar situations. Note that in this shorter extended rod configuration, the rod plug 10 is mounted in the storage hole 62 of the handle plug 60 as shown in FIG. 10C and explained above. Then, when the user wants to use the full length of the rod 22, he or she can pull on the base rod section 30 in the longitudinal direction indicated by the arrow 34 in FIG. 10C to dislodge the distal end 32 of the base rod section 30 from the nipple 67 and set screw 92 to fully extend the base rod section 30.

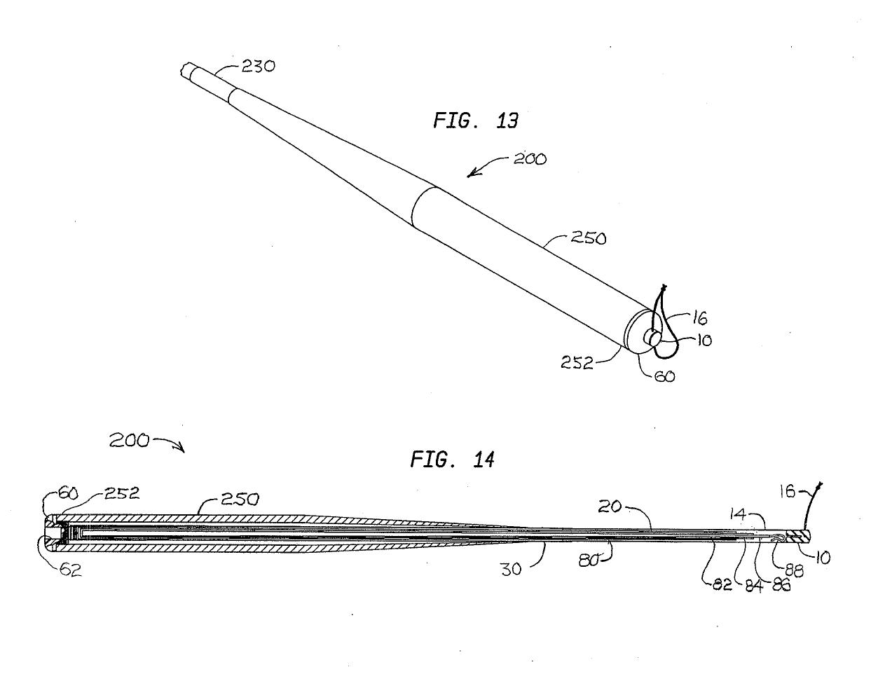

Another example fishing rod assembly 200 is shown in FIGS. 13 and 14, where a handle 250 is molded or otherwise formed or fixed directly onto the base rod section 230 and the handle plug 60 is screwed directly into the proximal end 252 of the handle 250. Otherwise, the fishing rod assembly 200 has much the same components as the example fishing rod assembly 100 described above. For example, the fishing rod assembly 200 may have the same rod sections, e.g., rod sections 30, 15, 80, 82, 84, 86, and string 88, or any other desired number of rod sections as explained above. As shown in FIG. 14, the same or similar rod plug 10 is provided in the distal end of the second rod section 14 (or any other rod section) when the intermediate and more distal rod sections are collapsed into the second rod section 40, and a handle plug 60 in the proximal end 252 of the handle 250 has the storage hole 62 for stowing the rod plug 10 when the rod sections are extended to the use configuration, as also explained above.

The details, components, and structures described above are examples of implementations of the invention, but other structures and components could also be used to implement the invention, which comprises a fishing rod assembly with a rod plug and a handle plug with a storage hole for stowing the rod plug when the rod sections of the fishing rod are extended for use. Other features of the invention can be discerned from the description above and the accompanying drawings in FIGS. 1-14, which form a part of this description.

The foregoing description is considered as illustrative of the principles of the invention. Furthermore, since numerous modifications and changes will readily occur to those skilled in art, it is not desired to limit the invention to the exact construction and process shown and described above. Accordingly, resort can be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

The embodiments of the invention in which an exclusive property or privilege is claimed are defined as follows:

1. A fishing rod assembly of a type that includes a rod comprised of multiple sections assembled together in a telescopic manner in which smaller diameter, more distal sections collapse telescopically into and extend telescopically out of one or more larger diameter, more proximal sections that extend from a handle, such fishing rod apparatus also having a rod plug sized and shaped for removable mounting in a distal end of the larger diameter section when the smaller diameter sections are telescopically collapsed into the larger diameter section, and a removable handle plug characterized by a storage hole in the removable plug that is sized and shaped to receive and retain the rod plug in a removable manner.

2. A fishing rod assembly of a type that includes a rod comprised of multiple sections assembled together in a telescopic manner in which smaller diameter sections collapse telescopically into and extend telescopically out of a distal end of a larger diameter base section that is slidable into and out of a handle characterized by a base section retainer apparatus that receives and releaseably holds a proximal end of the base section in the handle.

3. The fishing rod assembly of claim 2, wherein the base retainer apparatus includes a coupling insert in the handle that has a bore large enough in diameter to receive the proximal end of the base section and at an engagement feature in the coupling insert that engages the proximal end of the base section in a manner that yieldably inhibits longitudinal movement of the base section in relation to the coupling insert.

4. The fishing rod assembly of claim 3, wherein the engagement feature includes at least one set screw that extends transversely through the coupling insert into contact with the base section.

5. The fishing rod assembly of claim 4, wherein the set screw is radially adjustable.

6. A method of alternately securing and deploying rod sections of a fishing rod that has a handle with a handle plug and wherein the rod sections have different diameters and are arranged so that the rod sections with smaller diameters are telescopically collapsible into, and telescopically extendable out of at least one of the rod sections that has a larger diameter than the rod sections that have smaller diameters, comprising:
collapsing the rod sections that have smaller diameters telescopically into a distal end opening in the rod section that has the larger diameter, and plugging the distal end opening in the rod section that has the larger diameter with a rod plug which has a peripheral surface that is sized and shaped for a snug fit in the distal end opening in the rod section that has the larger diameter; and
deploying the rod sections by removing the rod plug from the distal end opening in the rod section that has the larger diameter, attaching the rod plug to the handle plug, and pulling the rod sections with the smaller diameters telescopically out of the rod section that has the larger diameter.

7. The method of claim 6, wherein the handle plug has a storage hole which is sized and shaped in a manner that accommodates receipt of the rod plug with a snug fit into the storage hole, and wherein the attaching of the rod plug to the handle plug includes inserting the rod plug snugly into the storage hole in the handle plug.

8. A method of stowing multiple sections of a fishing rod in a handle, comprising:
telescopically collapsing a plurality of the sections into a base section and collapsing the base section longitudinally into the handle; and
engaging the base section in the handle with an engagement feature that yieldably inhibits longitudinal movement of the base section in relation to the handle.
